(19) United States
(12) Patent Application Publication
(10) Pub. No.: US 2008/0289187 A1
(43) Pub. Date: Nov. 27, 2008

(54) Carabiner-handle scissors

(76) Inventor: John Anthony Fisher, Calgary (CA)

Correspondence Address: Antony C. Edwards, P.O. Box 26020, Westbank, BC, V4T 2G3, CA

(21) Appl. No.: 11/802,383

(22) Filed: May 23, 2007

(51) Int. Cl. B26B 13/22; F16B 45/02

(52) U.S. Cl. 30/123

(57) ABSTRACT

A pair of scissors having a pair of looped handles has a carabiner-style inwardly-opening gate mounted on the outer-most perimeter of one or both of the looped handles. The distal end of each gate, distal from the gates hinge, is oppositely disposed relative to the fulcrum of the pair of scissors. The non-gate portion of each of the looped handles containing a gate includes a hooked portion adjacent the distal end of each gate. The hooked portion includes a stop to limit movement of the gate.

### FIELD OF THE INVENTION

This invention relates to the field of scissors, shears and like double-handled pivotally coupled knife pairs, collectively referred to herein as scissors, and in particular to an improvement to same wherein a carabiner is incorporated into at least one of the handles.

### BACKGROUND OF THE INVENTION

Scissors are key pieces of equipment for medical personnel including but not limited to emergency medical response, rescue and veterinary professionals. In many instances, the scissors utilized by such medical personnel have been developed for specific applications such as emergency medical technician (“EMT”) shears, bandage and veterinary scissors. EMT shears, for example, are designed to cut through heavy fabrics such as denim or seatbelt material. Veterinary scissors, another type of specialized scissors, having one smooth blade and one serrated blade, are designed for cutting through cartilage and soft bone.

Scissors are often used by medical personnel in situations which, unlike a hospital operating room, are not conducive to the scissors being set down. If, for example, a rescuer in the midst of treating an injured hiker and preparing for him to be evacuated from a cliff overhang, sets down his scissors on the rocks, they may tumble and be lost. By way of another example, it would, in most instances, be ill-advised for a veterinarian treating a horse for a hoof abscess to set down her scissors on the ground. The laying of the scissors in close proximity to the equine could easily result in harm to the horse, the veterinarian or both.

In addition, in the corresponding examples noted above, it may well be of critical importance to the attending medical personnel that the scissors be readily to hand when needed. If an EMT attending on a car accident scene has, for example, used his scissors to cut the driver's seatbelt and, having nowhere to place the scissors, he sets them on the dash or places them into his pocket they may not be readily retrievable when the attending medical professional may have only one hand free with which to access then re-store the scissors.

### SUMMARY OF THE INVENTION

Trauma shears are awkward to carry because they are bulky. They don't fit well in pockets, and as a result, medical personnel do not carry them and are often looking for them when they should be paying attention to their patient. The user can carry the carabiner-handle scissor according to the present invention, for example, hooked to the waist of their hospital gowns, clipped to the side of stretchers, or clipped to cables in the emergency room or operating room or clipped to emergency vehicles and equipment.

In summary, the present invention may be characterized in one aspect as a carabiner-handle scissor which includes conventional scissor blades, that is, substantially linear elongate first and second levers mounted one to the other by a pivot joint so as to form a fulcrum substantially mid-way along their lengths, and wherein a first end of the levers are formed as shearing blades and wherein the second ends are formed as looped handles. The levers have cutting edges along opposed facing edges of the first and second levers respectively for shearing engagement of one of the cutting edges over the other as the levers are rotated relative to one another about the fulcrum between an open position wherein the cutting edges form a v-shaped nip for receiving in the nip an object to be cut, and a closed position wherein the cutting edges substantially overlap one another so as to close the nip along the length of the blades. The looped handles are formed as a pair of loops lying substantially adjacent a plane common with the cutting edges and containing a plane of rotation of the levers when rotated about the fulcrum.

A gate is formed in at least one of the loops and adapted for rotation about a hinge on a corresponding loop for opening of the gate only inwardly of the loop against a return biasing force of a resilient biasing means such as a spring cooperating with the gate to resiliently urge the gate into a closed position against a stop formed in the loop. When the gat is closed the loop forms a contiguous surface surrounding an inner circumference of the loop. When open, the gate forms an opening into the loop through a discontinuity in the looped handle. The gate is opened by being resiliently urged inwardly of the loop into its open position against the return biasing force. The return biasing force closed the gate when it is released.

In one embodiment each loop of the pair of loops includes a first bearing member and a second bearing member. The first and second bearing members are disposed oppositely to each other on each loop. The first bearing members are substantially closely adjacent when the levers are in the closed position. The second bearing members are thereby spaced apart by substantially only the pair of loops. At least one gate is formed in at least one of the second bearing members.

As in conventional scissors a first loop of the pair of loops is adapted to only receive in sliding engagement journalled therethrough a thumb of a first hand of a user and a second loop of the pair of loops is adapted to receive in sliding engagement journalled therethrough at least two fingers of the first hand of the user. In one embodiment of the present invention the gate is only formed in the second loop.

The gate may include an elongate gate member pivotally mounted to a shank of its corresponding loop by a hinge. The hinge is disposed on a side of the gate opening closest to the fulcrum so that a distal end of the gate member distal from the hinge is disposed oppositely from the fulcrum about the hinge.

### BRIEF DESCRIPTION OF THE DRAWINGS

FIG. 1 is, in front elevation open position view, a pair of scissors according to one embodiment of the present invention incorporating an oppositely disposed pair of carabiners in the handles.

FIG. 2 is, in a front elevation closed position, the pair of scissors of FIG. 1 hooked onto a pocket.

FIG. 3 is, in partially cut away enlarged view, the upper carabiner and handle of the pair of scissors of FIG. 2.

FIG. 4 is, in front elevation view, the scissors of FIG. 1 being grasped by a user of the scissors and with the carabiners in their closed position.

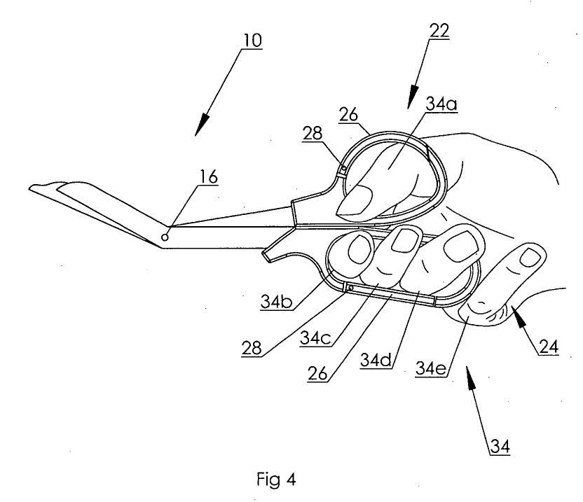

FIG. 5 is the view of FIG. 4 with the carabiner on the thumb handle being opened by the user's thumb.

FIG. 6 is the view of FIG. 4 with the carabiner of the finger handle being opened by the user's fingers.

### DETAILED DESCRIPTION OF EMBODIMENTS OF THE INVENTION

In the accompanying figures similar characters of reference denote corresponding parts in each view.

Carabiner-handle scissor 10 includes substantially linear elongate first and second levers 12 and 14 respectively mounted one to the other by a pivot joint 16 so as to form a fulcrum substantially mid-way along their lengths L₁ and L₂ respectively.

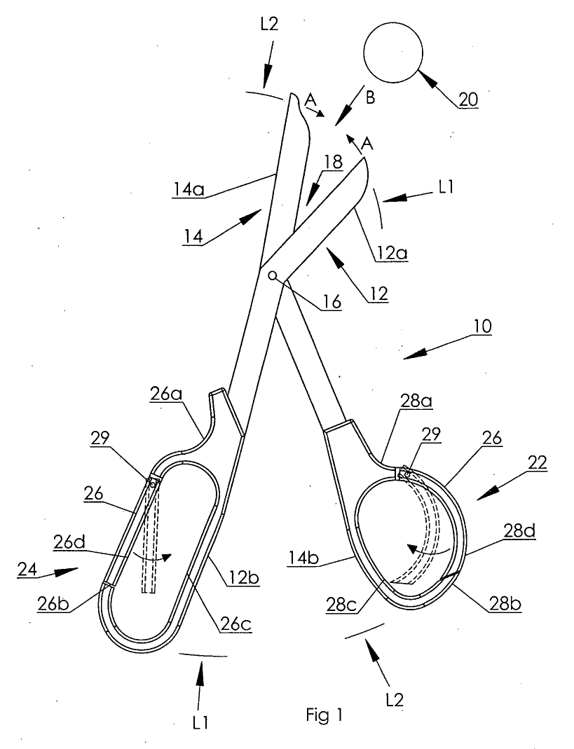

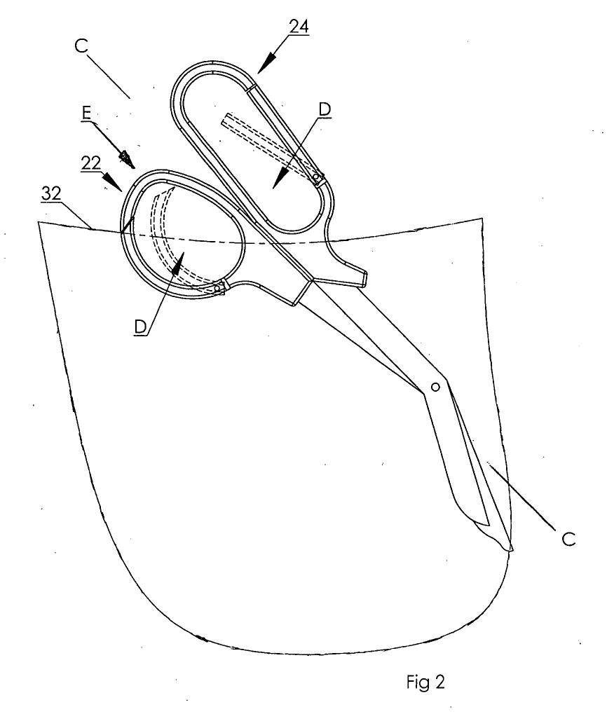

A first end 12a and 14a respectively of each of said first and second levers 12 and 14 are formed as shearing or cutting blades having cutting edges along opposed facing edges of said first and second levers respectively. The cutting edges are for shearing engagement of one of said cutting edges over the other as said levers are rotated towards each other in directions A relative to one another about the fulcrum, that is about pivot point 16, between an open position such as seen in FIG. 1 wherein the cutting edges form a v-shaped nip 18 for receiving in the nip 18 in direction B an object 20 to be cut, and a closed position such as seen in FIG. 2 wherein said cutting edges substantially overlap one another so as to close the nip 18 along the length of said blades.

A second end 12b and 14b respectively of each of the first and second levers 12 and 14, opposite the first ends 12a and 14a, are formed as handles. The handles include a pair of corresponding loops 22 and 24 lying substantially adjacent a plane C common with the cutting edges when in the closed position and lying substantially in a plane of rotation of the levers when rotated about the fulcrum. Each loop has a substantially contiguous surface surrounding an inner circumference of the loop when a corresponding gate 26 is in the closed position. Gates 26 are shown in their open position in dotted outline. When a gate 26 is opened by rotation in direction D an opening 30 is formed into the loop through the corresponding discontinuity in the inner circumference of the loop.

Each gate 26 may have a corresponding leaf spring (not shown) or the like or other resilient biasing means extending from the gate into the base shank 26a, 28a of the corresponding loop. Gates 26 only open inwardly of said loop, that is in direction D, about hinges 29, against a return biasing force of the resilient biasing means such as the leaf springs. The leaf springs cooperate with their corresponding gate 26 to resiliently urge gate 26 into the closed position, as illustrated, against a stop or lip 26b, 28b respectively formed in the corresponding loop.

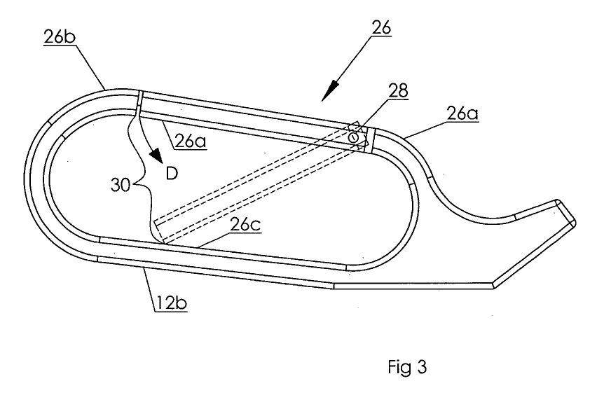

As seen in FIG. 3, which is an enlarged view of a representative loop such as loop 24, each loop may include a first bearing member and a second bearing member, the second bearing member is disposed oppositely on each loop from the first bearing member. The first bearing members 26c, 28c are closely adjacent when the levers 12, 14 are in their closed position. The second bearing members 26d, 28d are spaced apart from each other by the cumulative diameters of the pair of loops. In one embodiment a gate is formed in at least one of the second bearing members, that is, on the outer curvatures of the loops.

In one form of scissors, a first loop 22 of the pair of loops is adapted to only receive in somewhat snug sliding engagement journalled therethrough a thumb 34a of a first hand of a user. This is usually accomplished by sizing and shaping the thumb loop 22 to only comfortably receive thumb 34a. The opposite second loop 24 of the pair of loops is normally adapted to receive in sliding engagement journalled therethrough at least two fingers for example fingers 34b, 34c, 34d of the first hand of the user. In one embodiment, the scissors only have a single gate and that gate is only formed on the second loop, that is only on the fingers loop 24, or only on the first loop, that is only on the thumb loop 22.

Each gate 26 includes an elongate gate member pivotally mounted by hinges 29 to the base shanks 26a, 28a. Each hinge 29 is advantageously disposed as illustrated on an end of the gate closest to pivot joint 16 so that a distal end of the gate member distal from the hinge is disposed oppositely from pivot joint 16.

Thus in use, scissors 11 may be grasped by a single hand of a user, for example about the mid point along the closed blades and one of the loops, for example loop 22 as illustrated, driven in direction E onto an upper lip 32 of an open pocket (shown in dotted outline), belt, belt loop, webbing, etc. This pushes lip 32 into the opening 30 formed as gate 26 on loop 22 opens, that is, pivots about hinge 29 as a result of the force of engaging against the lip. Once the scissors and gate are released from the grasp of the users the gate springs back towards its closed position pinching the lip and securing the scissors from where they may be easily later retrieved.

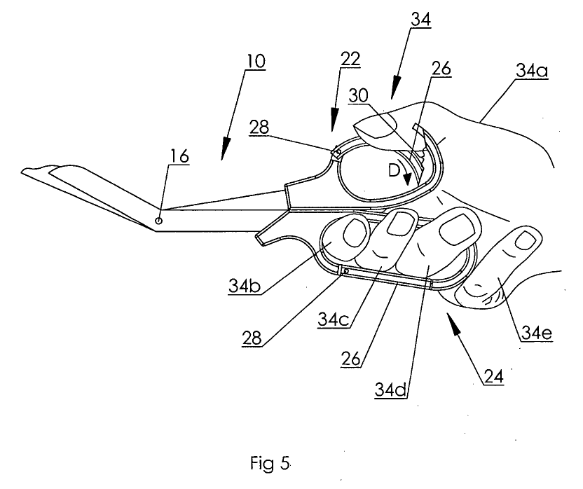

Alternatively, for single-handed use as illustrated in FIG. 5, the user may, leaving one or more fingers 34b-34e in loop 24, remove thumb 34a from loop 22, place thumb 34a on the corresponding gate 26 and apply force in direction D against that gate thereby driving the gate inwardly into loop 22 creating opening 30. Loop 22 may then be driven in direction E onto an upper lip 32 of an open pocket as illustrated in FIG. 2, or onto any other suitable receptacle such as the waist of hospital gowns, the sides of stretchers, and on cables in the emergency room or operating room, and on emergency vehicles and equipment, allowing scissors 10 to be stored with one hand while leaving the other hand free.

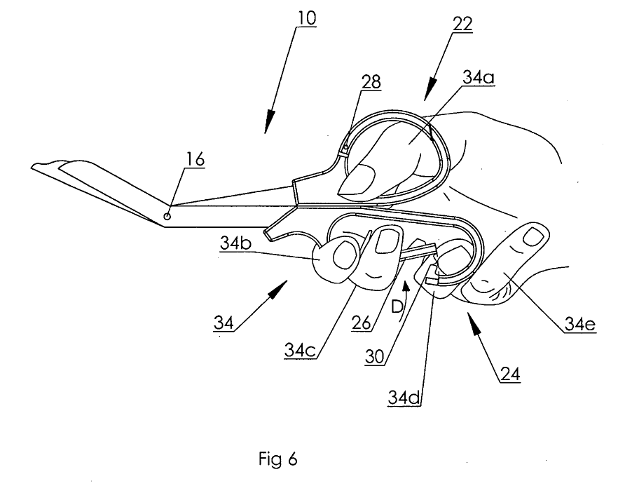

In a further alternative use of the present invention, the user may leave thumb 34a in loop 22 and remove one or more of fingers 34b, 34c, 34d and 34e and place such finger(s) on the corresponding gate 26 of loop 24. Without intending to be limiting, FIG. 6 illustrates fingers 34c and 34d which are removed from the inside of loop 24 and placed on gate 26. When fingers 34c and 34d apply force in direction D against that gate it is driven inwardly into loop 24 creating opening 30. Loop 24 may then be driven in direction E onto a lip 32 of an open pocket, or any other suitable receptacle thereby allowing scissors 10 to be stored with one hand while leaving the other hand free.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. A carabiner-handle scissor comprising:
substantially linear elongate first and second levers mounted one to the other by a pivot joint so as to form a fulcrum substantially mid-way along their lengths,
a first end of each of said first and second levers formed as shearing blades having cutting edges along opposed facing edges of said first and second levers respectively for shearing engagement of one of said cutting edges over the other as said levers are rotated relative to one another about said fulcrum between an open position wherein said cutting edges form a v-shaped nip for receiving in said nip an object to be cut, and a closed position wherein said cutting edges substantially overlap one another so as to close said nip along the length of said blades,
a second end of each of said first and second levers, opposite said first ends, formed as a pair of loops lying substantially adjacent a plane common with said cutting edges and containing a plane of rotation of said levers when rotated about said fulcrum, and wherein a gate is formed in at least one of said loops and adapted for rotation about a hinge on a corresponding loop for opening of said gate only inwardly of said loop against a return biasing force of a resilient biasing means cooperating with said gate to resiliently urge said gate into a closed position against a stop formed in said loop thereby forming said loop as a contiguous surface surrounding an inner circumference of said loop when said gate is in said closed position, and forming an opening into said loop through a discontinuity in said inner circumference and said loop when said gate is resiliently urged inwardly of said loop into an open position against said return biasing force.

2. The scissors of claim 1 wherein each loop of said pair of loops include a first bearing member and a second bearing member disposed oppositely on said each loop from said first bearing member, and wherein said first bearing members are substantially closely adjacent when said levers are in said closed position and said second bearing members are thereby spaced apart by said pair of loops, and wherein said at least one gate is formed in at least one of said second bearing members.

3. The scissors of claim 2 wherein a first loop of said pair of loops is adapted to only receive in sliding engagement journalled therethrough a thumb of a first hand of a user and wherein a second loop of said pair of loops is adapted to receive in sliding engagement journalled therethrough at least two fingers of the first hand of the user, and wherein said at least one gate is only formed in only said second loop.

4. The scissors of claim 1 wherein said gate includes an elongate gate member pivotally mounted to a shank of said loop by a hinge, and wherein said hinge is disposed on a side of said gate opening closest to said fulcrum so that a distal end of said gate member distal from said hinge is disposed oppositely from said fulcrum about said hinge.
